(19) United States
(12) Patent Application Publication
(10) Pub. No.: US 2009/0178647 A1
(43) Pub. Date: Jul. 16, 2009

(54) Fuel feeding mechanism of a vehicle with an acceleration pedal position sensor

(76) Inventor: Chun-Chih Wang, Nanhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,825

(22) Filed: Jan. 16, 2008

(51) Int. Cl. G05G 1/14; F02D 11/10; B60K 26/02

(52) U.S. Cl. 123/399; 74/514; 701/110

(57) ABSTRACT

A fuel feeding mechanism of a vehicle with an acceleration pedal position sensor includes an electronic control unit, and a throttle; the throttle is equipped with a feedback signal device, and the feedback signal device is connected to the electronic control unit; the throttle includes a pivotal shaft; a throttle position sensor is connected to the pivotal shaft of the throttle; a signal source is connected to the throttle position sensor as well as the feedback signal device of the throttle; furthermore, an accelerator pedal position sensor is connected to the electronic control unit to interfere in and change a signal of the throttle together with the throttle position sensor, thus helping to advance the time of the vehicle shifting gears and reduce fuel consumption.

### BACKGROUND OF THE INVENTION

1. Field of the Invention

The present invention relates to a fuel feeding mechanism of a vehicle with an accelerator pedal position sensor, more particularly one, which includes a throttle position sensor, and an acceleration pedal position sensor; the throttle position sensor is equipped with a signal source, and can interfere in and change a signal of the throttle together with the acceleration pedal position sensor to help to advance a time of the vehicle shifting gear and reduce fuel consumption.

2. Brief Description of the Prior Art

Vehicles are among necessities of daily life, which provide people with better mobility and convenience. Most of the fuels of vehicles are extracted from petroleum. Petroleum isn't a kind of inexhaustible natural resource, and it can be dried up very soon. Furthermore, combustion of petrolic fuels will produce much air pollution. In order to deal with the above problems, many manufacturers are devoting much money and time to developing better products and manufacturing method so that less energy is consumed in manufacturing. In the light of the fact that a large proportion of gasoline is consumed with vehicles, many people decide to reduce use of cars as much as possible, and the industry are devoting much effort to developing more advanced fuel feeding mechanisms for vehicles in order for the vehicles to consume less fuel in running.

A kind of currently existing vehicle fuel-feeding mechanism includes an electronic control unit, and a throttle. The throttle comprises a pivotal shaft, and a valve pivoted on the pivotal shaft, and is equipped with a feedback signal device. The feedback signal device is connected with the electronic control unit. Furthermore, a throttle position sensor is connected with the pivotal shaft of the throttle, which sensor is equipped with a variable resistor capable of changing in resistance in rotation.

The above vehicle fuel-feeding mechanism is found to have the following drawbacks:

1. With the fuel-feeding mechanism, the engine of the vehicle will increase the rotational speed in order to speed up the vehicle in gear-shifting. Consequently, a large amount of fuel will be consumed.

2. For the above reason, many drivers decide to re-equip their car engines in order to reduce the expense on fuel. However, such a re-equip takes much money, and re-equips are usually different for the engines of vehicles of different models.

### SUMMARY OF THE INVENTION

In the light of the fact that the above vehicle fuel-feeding mechanism will consume a much greater amount of fuel in gear-shifting, and it will take much time, labor, and expense to re-equip the vehicle engine, the inventor of the present invention has been devoting much time and effort to developing an improvement on a vehicle fuel-feeding mechanism of a vehicle, which includes an acceleration pedal position sensor, and a throttle position sensor equipped with a signal source; the throttle position sensor will interfere in and change a signal of the throttle together with the acceleration pedal position sensor, thus being capable of helping to advance a time of the vehicle shifting gear and reduce fuel consumption.

A fuel feeding mechanism according to an embodiment of the present invention includes an electronic control unit, and a throttle. The throttle includes a pivotal shaft and a valve pivoted on the pivotal shaft, and is connected with a feedback signal device. The feedback signal device is connected to the electronic control unit. A throttle position sensor is connected to the pivotal shaft of the throttle; the throttle position sensor includes a variable resistor, which will change in resistance on rotation, and which is connected with a signal source connected with the feedback signal device of the throttle. Furthermore, an acceleration pedal position sensor is connected to the electronic control unit; the throttle position sensor can interfere in and change a signal of the throttle together with the acceleration pedal position sensor so as to help to advance a time of the vehicle shifting gear and reduce fuel consumption. The fuel feeding mechanism of the present invention can be used with vehicles of any model without re-equipping the engines of the vehicles.

### BRIEF DESCRIPTION OF THE DRAWINGS

The present invention will be better understood by referring to the accompanying drawings, wherein:

FIG. 1 is a perspective view of the present invention,

FIG. 2 is a view of connections of the various components of the present invention,

FIG. 3 is a circuit diagram of the present invention,

FIG. 4 is an enlarged perspective view of the present invention,

FIG. 5 is an enlarged perspective view of the present invention, and

FIG. 6 is a circuit diagram of the throttle position sensor of the present invention.

### DETAILED DESCRIPTION OF THE PREFERRED EMBODIMENTS

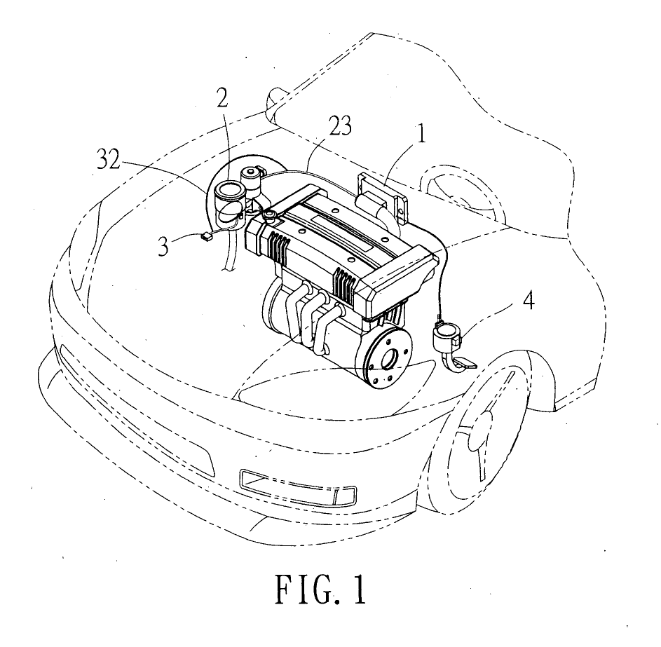

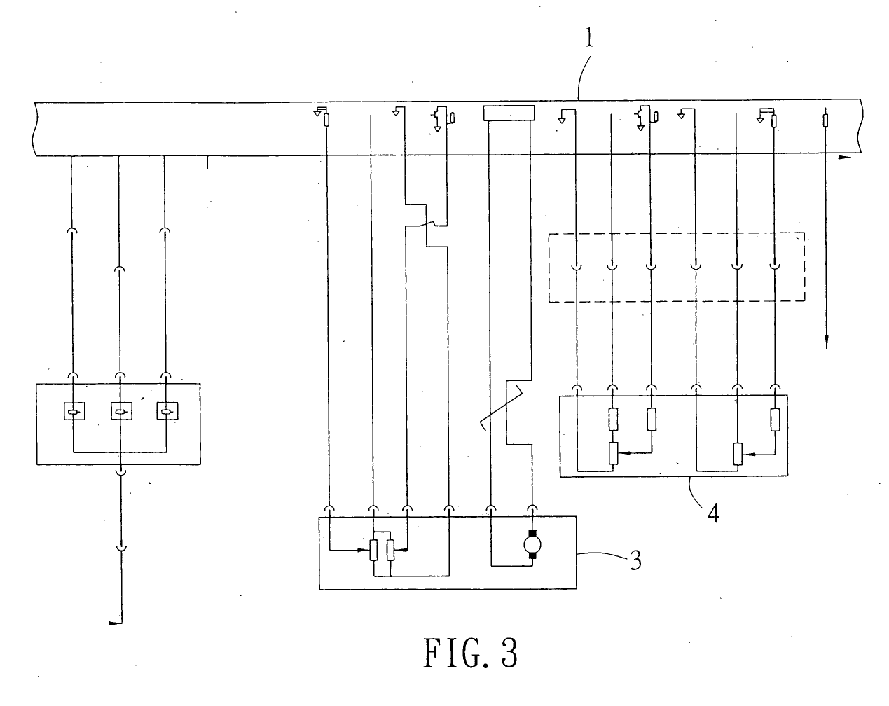

Referring to FIG. 1 to FIG. 3, a preferred embodiment of a fuel feeding mechanism of a vehicle with an acceleration pedal position sensor in the present invention includes an electronic control unit (ECU) 1, a throttle 2, a throttle position sensor (TPS) 3, and an acceleration pedal position sensor (APS) 4.

The electronic control unit 1 is used to control the throttle 2, the throttle position sensor 3, and the acceleration pedal position sensor 4, and can control operation of an engine of the vehicle in order for allowing an optimum amount of fuel to be injected, and ignition to take place at an optimum time.

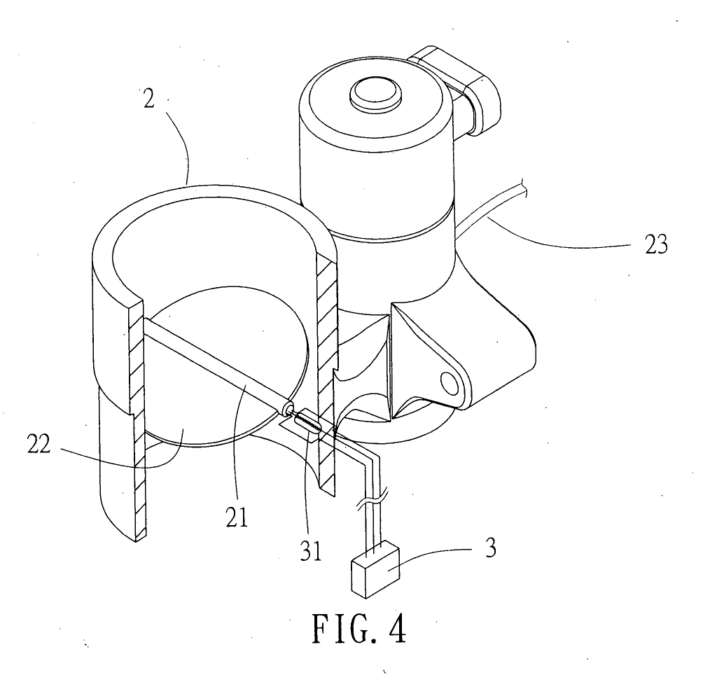

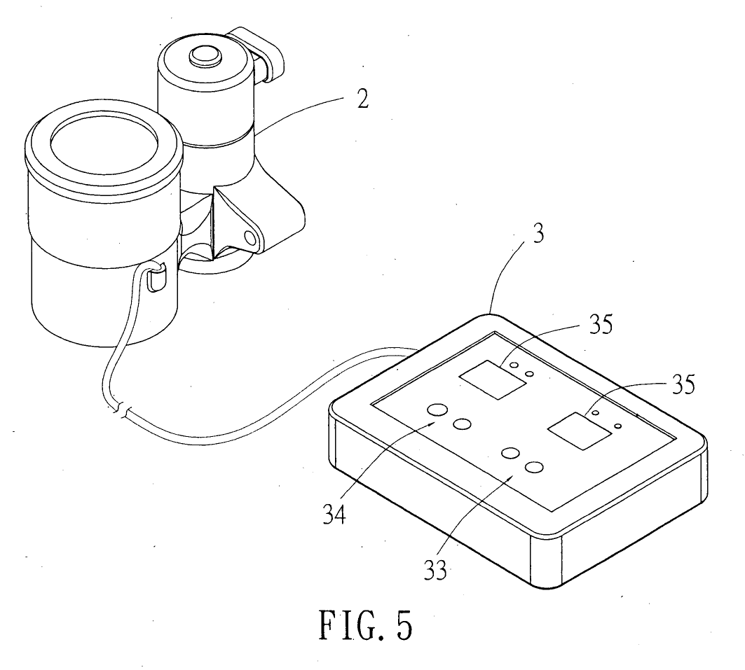

The throttle 2 is a valve of a butterfly-shaped type. Referring to FIG. 4 as well, the throttle 2 comprises a pivotal shaft 21, and a valve 22 pivoted on the pivotal shaft 21. Furthermore, the throttle 2 is connected to a feedback signal device 23.

The throttle position sensor 3 is co-movable with the throttle 2 to provide the electronic control unit 1 with the update data of the throttle open degree so that the electronic control unit 1 can compare the throttle open degree with the rotational speed of the engine, and make the engine run on an optimum amount of fuel injection, and the ignition take place at an optimum time. Consequently, the combustion efficiency and power increase, and fuel consumption reduces.

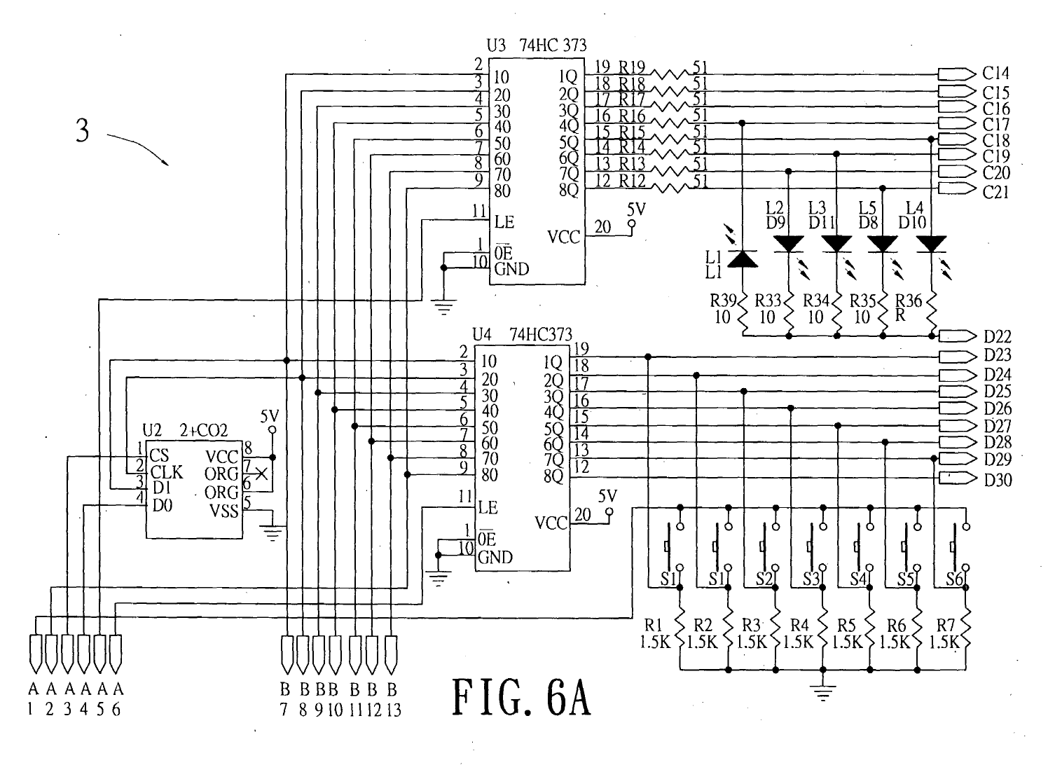

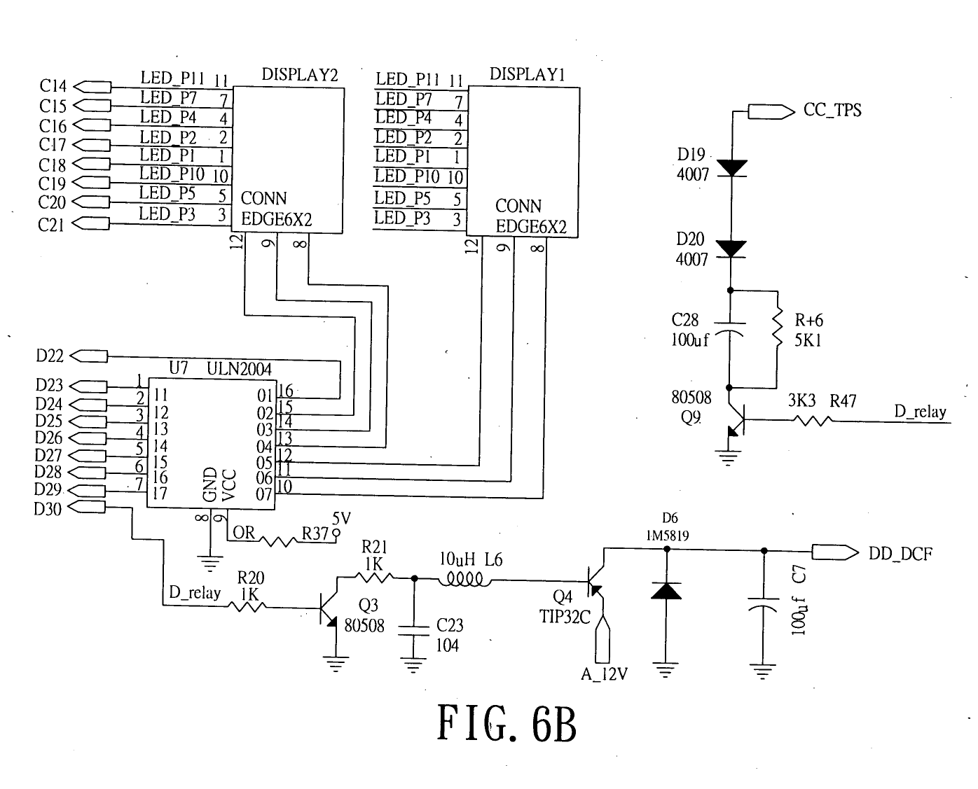

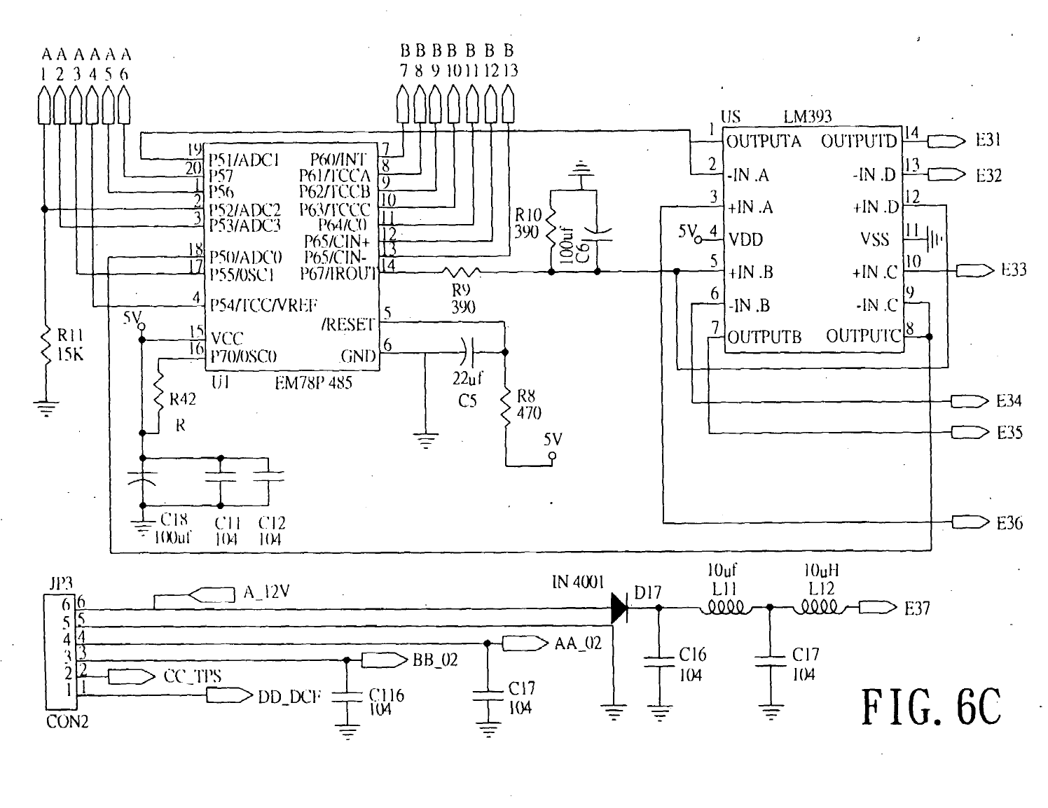

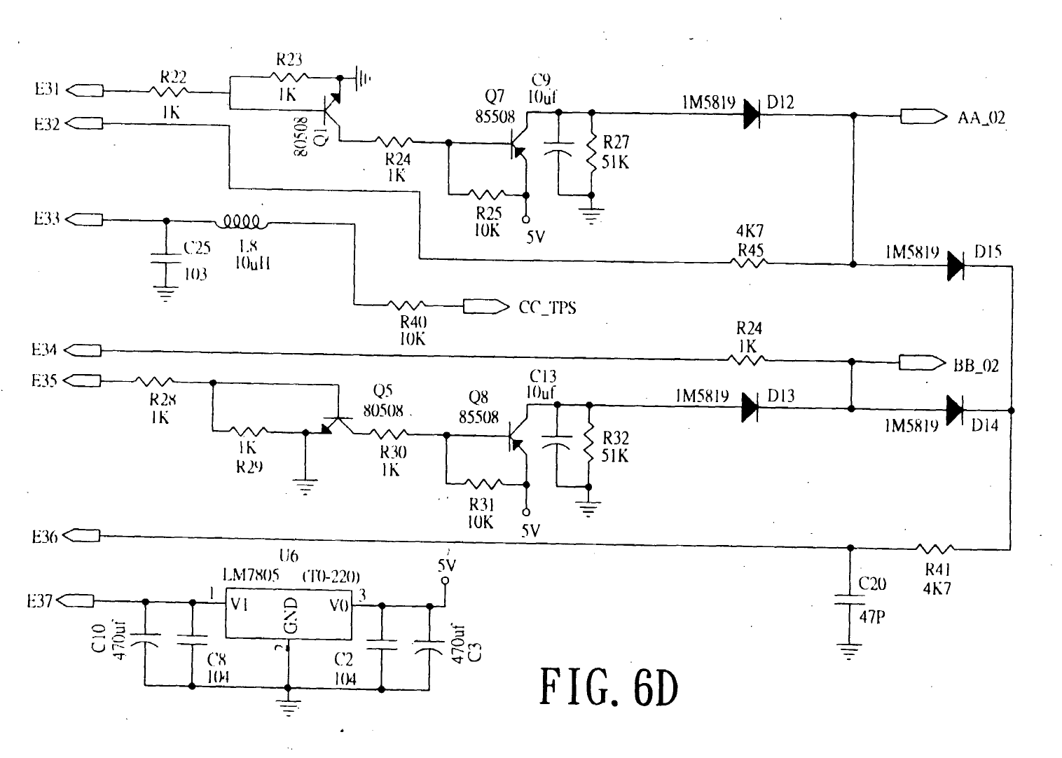

Referring to FIGS. 5 and 6 as well, throttle position sensor 3 includes a variable resistor 31, which will change in its resistance when being rotated. The throttle position sensor 3 includes a signal source 32, which is connected to the variable resistor 31. Referring to FIGS. 4 and 5 as well, the throttle position sensor 3 further includes adjustment buttons 33 for a start of the throttle position sensor 3, adjustment buttons 34 for stoppage of the throttle position sensor 3, and indicating lamps 35. The adjustment buttons 33 for start are used to set a floor value of a rotational speed of the engine; the throttle position sensor 3 will be activated, and a stable voltage will be transmitted to the electronic control unit 1 as soon as the rotational speed of the engine reaches the floor value. The adjustment buttons 34 for stoppage are used to set a ceiling value of a rotational speed of the engine; the throttle position sensor 3 will be turned off, and a stable voltage will be transmitted to the electronic control unit 1 as soon as the rotational speed of the engine reaches the ceiling value. The indicating lamps 35 are used to show a current set value of rotational speed of the engine in the above setting.

The accelerator pedal position sensor 4 is connected to the electronic control unit 1, and will detect motion of the accelerator pedal of the vehicle; the distance value that the accelerator pedal of the vehicle has been moved will be sent to the electronic control unit 1 through a potentiometer, and the electronic control unit 1 will control the throttle 2 in order for the valve 22 to open to a certain degree according to the above-mentioned distance value as well as the signal of the throttle position sensor 3.

In assembly, referring to FIG. 1 to FIG. 4, the feedback signal device 23 of the throttle 2 is connected to the electronic control unit 1; thus, a signal of the valve 22 opening is feedback to the electronic control unit 1 in order for the electronic control unit 1 to make the engine run on an optimum amount of fuel injection. The variable resistor 31 of the throttle position sensor 3 is installed on the pivotal shaft 21 of the throttle 2 so that the variable resistor 31 will change in its resistance in rotational motion of the pivotal shaft 21. The signal source 32 of the throttle position sensor 3 is connected to feedback signal device 23 of the throttle 2, and the acceleration pedal position sensor 4 is connected to the electronic control unit 1 so that the throttle position sensor 3 can work together with the acceleration pedal position sensor 4 to provide the electronic control unit 1 with a signal, which is slightly smaller than the signal feedback from the throttle 2 to the electronic control unit 1, so as to interfere in and change the signal of the throttle 2. Therefore, the time of the vehicle shifting gears is advanced. For example, the rotational speed of the vehicle engine is 2500 RPM/60 KM originally, and will become 2200 RPM/60 KM after the signal is changed.

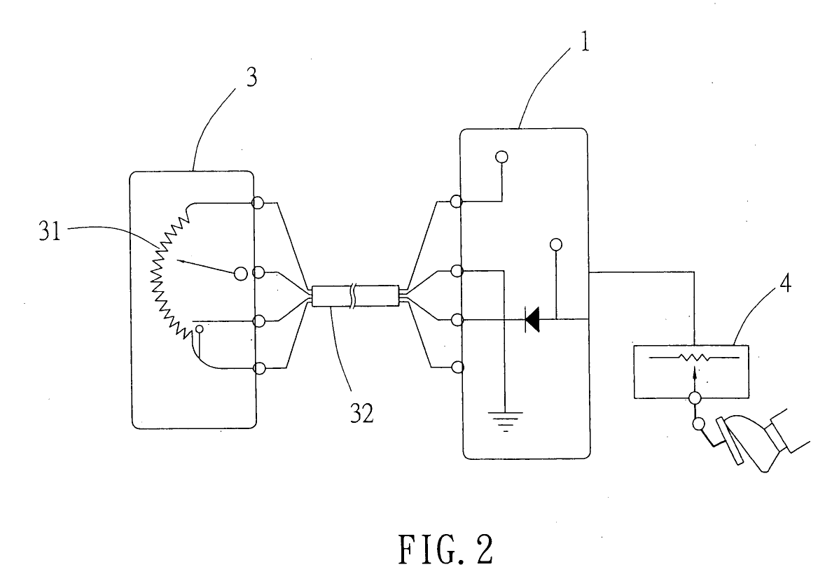

To put the fuel feeding mechanism of the present invention to use, referring to FIGS. 2, 5, and 6, the driver uses the adjustment buttons 33 to set a floor value of rotational speed of the engine, and uses the adjustment buttons 34 to set a ceiling value of rotational speed of the engine according to the model and the exhaust amount of the vehicle. Therefore, in the course of the vehicle shifting gears, the rotational speed of the engine will be in the range of the floor value to the ceiling value. The throttle position sensor 3 will move together with the valve 22 of the throttle 2 to provide the electronic control unit 1 with the update data of the open degree of the valve 22, and the throttle position sensor 3 will provide the electronic control unit 1 with a signal through the signal source 32, which signal is slightly smaller than the signal feedback from the throttle 2 to the electronic control unit 1, so as to change the signal of the throttle 2. At the same time, the acceleration pedal position sensor 4 will provide the electronic control unit 1 with the distance value that the accelerator pedal of the vehicle has been moved, and the electronic control unit 1 will compare the open degree of the valve 22 and the rotational speed of the engine with the distance value that the accelerator pedal has been moved; thus, the electronic control unit 1 will adjust the amount of fuel injection of the engine to make the vehicle shift gears earlier when the rotational speed of the engine reaches the rotational speed value of the engine set by the driver. In other words, the throttle position sensor 3 will work together with the acceleration pedal position sensor 4 to send a stable voltage feedback to the electronic control unit 1, and in turn the electronic control unit 1 will control the fuel injector so as not to inject additional fuel in gear-shifting of the vehicle, thus helping to save fuel.

From the above description, it can be seen that the fuel feeding mechanism of the present invention has the following advantages over the prior art:

1. The throttle position sensor of the present invention includes a variable resistor, and a signal source, which is connected to the variable resistor as well as the feedback signal device of the throttle. Therefore, the throttle position sensor can interfere in and change the signal of the throttle together with accelerator pedal position sensor so as to help to advance the time of the vehicle shifting gears and reduce consumption of fuel.

2. The fuel feeding mechanism is suitable for use with vehicles of any model to save fuel. And, it is more economical to use the fuel feeding mechanism because it isn't necessary for the driver to have the vehicle engine re-equipped. Therefore, the present invention is very practical.

What is claimed is:

1. An improvement on a fuel feeding mechanism of a vehicle with an acceleration pedal position sensor, comprising
an electronic control unit,
a throttle, the throttle including a pivotal shaft, and a valve pivoted on the pivotal shaft; the throttle including a feedback signal device, which is connected to the electronic control unit;
a throttle position sensor connected to the pivotal shaft of the throttle;
an accelerator pedal position sensor connected to the electronic control unit to control the throttle together with the throttle position sensor; and
a signal source, the signal source being connected to both the throttle position sensor and the electronic control unit.

2. The improvement on a fuel feeding mechanism of a vehicle with an acceleration pedal position sensor as claimed in claim 1, wherein the signal source of the throttle position sensor is connected to the feedback signal device of the throttle.

3. The improvement on a fuel feeding mechanism of a vehicle with an acceleration pedal position sensor as claimed in claim 1, wherein the throttle position sensor has a plurality of adjustment buttons for start, a plurality of adjustment buttons for stoppage, and a plurality of indicating lamps.
